(19) United States
(12) Patent Application Publication
(10) Pub. No.: US 2007/0229515 A1
(43) Pub. Date: Oct. 4, 2007

(54) Image forming apparatus and image forming control program

(75) Inventor: Yasushi Tsukamoto, Osaka (JP)

Correspondence Address: FOLEY AND LARDNER LLP;SUITE 500, 3000 K STREET NW, WASHINGTON, DC, 20007, US

(73) Assignee: KYOCERA MITA CORPORATION

(21) Appl. No.: 11/727,538

(22) Filed: Mar. 27, 2007

(30) Foreign Application Priority Data
Mar. 29, 2006 (JP) JP 2006-90072
Mar. 29, 2006 (JP) JP 2006-90073

(51) Int. Cl. G06T 11/00

(52) U.S. Cl. 345/471; 358/1.11

(57) ABSTRACT

An image forming apparatus of the present invention includes a font data storing section for storing font data; an input section for inputting image data and font data used for this image data from outside; and a font data addition control section for recognizing the font data used for this image data when this image data is inputted to this input section, and out of the font data thus recognized, controlling to add and store in the font data storing section insufficient font data that is not stored in the font data storing section. As a result, when the image data such as document data is inputted from outside, even if the font data used for this image data is insufficient on the side of input, this insufficient font data can be replenished.

### BACKGROUND OF THE INVENTION

1. Field of the Invention

The present invention relates to an image forming apparatus and an image forming control program, and for example, relates to the image forming apparatus and the image forming control program preferably mounted on a composite machine (MFP: Multi Function Peripheral) having a composite function such as a printer, a copying machine, and a facsimile equipment, or the like.

2. Description of the Related Art

In recent years, in the MFP of this kind, an apparatus that can be used in a plurality of languages such as English, Korean, and Chinese other than Japanese has bee provided, and for example, a structure as will be described below is known.

Namely, as shown in FIG.5, the MFP of this kind is so constituted that in a printer control section 1, font data from a print font data storing section 3 is used for inputted printer data and print image data is thereby prepared, and the print image data thus prepared is outputted to an image control section 5. Then, document image data inputted from an external memory, etc, through an input section 7 is outputted to the image control section 5. In addition, based on an instruction from a display panel 11 through a panel control section 9, the print image data or the document image data is outputted from the image control section 5 to a print processing section 13, which is then printed by the print processing section 13. Further, the image data is outputted from the image control section 5 to a transmission control section 15. Then a transmission image control section 19 adds names and IDs of a transmission source and a transmission destination to a header and a footer of the image data by using transmission font data from a transmission font data storing section 17, and faxes it to an external network (not shown). Further, various display data from the image control section 5 is displayed on the display panel 11 through the panel control section 9.

A designation mark 21 in FIG. 5 indicates a display font data storing section where display font data displayed on the display panel 11 is read/written by the panel control section 9, and a designation mark 23 indicates a scanner processing section where document data is read and is outputted to the image control section 5 as image data.

When such an MFP is made to comply with a plurality of languages, unless a desired language is stored respectively in the print font data storing section 3, the transmission font data storing section 17, and the display font data storing section 21, the print image data can not be prepared and a character can neither be added to the image data nor be displayed on the display panel 11. However, a significantly high cost is required for previously storing and providing a plurality of language font data, and a required language is different for each user.

Therefore, in a conventional MFP, one or two main language font (such as Japanese and alphameric characters) are stored in the display font data storing section 21 as standard languages, in addition to the language of a country where the equipment is set, and a changeover display of the plurality of languages can be made possible on only the display panel 11, thus complying with the plurality of languages by reducing a trouble in panel operation.

Note that as patent documents of this kind capable of complying with the plurality of languages, Japanese Patent Laid Open No. 07-115490 (Patent document 1) and Japanese Patent Laid Open No. 09-107453 (Patent document 2) are given as examples.

However, in the aforementioned MFP, when optional language font data is added to the display font data storing section 21, a display of an additional language is enabled on the display panel 11, but there is a problem that such additional language can not be displayed even when the document data is inputted by using the font data not stored in the display font data storing section 21 such as an address book, etc, used for transmitting and receiving data.

In addition, a large storage capacity in an inner storing section is required for adding the optional language font data, and the font data not used for the inputted image is also stored therein, thus easily generating an uneconomical condition.

Particularly, in the MFP, transmission/reception of data through a network is performed. Accordingly, an address book complying with a plurality of languages is required, and it is extremely inconvenient if some of the language addresses can not be used.

Further, when no font data exits in the print font data storing section 3 and the transmission font data storing section 17, it is impossible to display the address book, etc, inputted from the input section 7, and in addition, the font data can not be added to the transmitted image data. If the font data is tried to be added, a problem involved therein is that only a standard language is allowed to be added.

In recent years, the aforementioned MFP has been used in each country and has been connected through a network. Therefore, an improvement in the aforementioned problems is strongly desired to comply with a plurality of languages.

### SUMMARY OF THE INVENTION

In order to solve the above-described problems, the present invention is provided, and an object of the present invention is to provide an image forming apparatus and an image forming control program capable of performing a display, etc, of image data without trouble, even if font data used for inputted image data is insufficient in this apparatus.

Another object of the present invention is to provide the image forming apparatus and the image forming control program possible to capture insufficient font data together with input image data, even if the font data used for inputted image data is insufficient in this apparatus.

Still another object of the present invention is to provide the image forming apparatus and the image forming control program possible to capture the insufficient font data from outside, even if the font data used for the inputted image data is insufficient in this apparatus.

In order to solve the above-described problems, the present invention takes several aspects as follows.

a first aspect of the present invention provides an image forming apparatus, including:

a font data storing section for storing font data;

an input section for inputting from outside image data and font data used for this image data; and

a font data addition control section for recognizing the font data used for this image data when this image data is inputted to the input section and out of the font data thus recognized, controlling to add and store in the font data storing section insufficient font data that is not stored in the font data storing section.

Further, according to the present invention, an address book can serve as the aforementioned image data.

In addition, according to the present invention, a font control section may also be provided for controlling to perform format conversion of the aforementioned font data, in accordance with a display mode or an image forming mode.

Then, the image forming control program according to the first aspect makes a computer for image forming control that controls to add the insufficient font data that is not stored in the font data storing section where the font data is previously stored, execute an input processing for inputting from the input section the image data and the font data used for this image data; and a font data addition processing for controlling to add and store in the font data storing section the insufficient font data that is not stored in the font data storing section out of the font data used for the inputted image data, when this image data is inputted.

According to the first aspect of the present invention, the font data is previously stored, and the image data and the font data used for this image data are inputted from outside, and when this image data is inputted, the font data used for this image data is recognized, and out of the font data thus recognized, the insufficient font data that is not previously stored in the font data storing section is controlled to be added and stored. Therefore, even if the font data used for the image data such as inputted document data is insufficient on the input side, it can be inputted together with the image data, thus making it possible to display the image data.

Also, when the aforementioned image data serves as the address book, the quantity of the image data is small, and the insufficient font data that is not stored in the font data storing section is also small. Therefore, a required storage capacity may be small and an advantage is that a high speed operation is attained.

Further, by controlling to perform format conversion of the font data as described above in accordance with the display mode and the image forming mode, the font data can be flexibly used depending on various modes, such as displaying a common font data or adding it to the image data.

A second aspect of the present invention provides the image forming apparatus connected to a network, including the font data storing section for storing the font data; the input section for inputting the data forming the image data; the font data addition control section for detecting insufficient font information on the insufficient font data that is not stored in the font data storing section and controlling to add and store the insufficient font data in the font data storing section when this insufficient font data is inputted; and a font data retrieval control section for controlling to output the insufficient font data in the font data addition control section when this insufficient font data is acquired by controlling to retrieve it in an information processing apparatus connected to the aforementioned network based on the insufficient font information.

In addition, according to the second aspect of the present invention, the address book serves as the aforementioned image data.

Also, according to the present invention, the font control section may be provided, for controlling to perform format conversion of the aforementioned font data in accordance with the display mode or the image forming mode.

The image forming control program according to the second aspect of the present invention makes the computer for image forming control connected to the network which is capable of adding the font data in the font data storing section where the font data is stored, execute the input processing for inputting the data forming the image data; a font detecting processing for detecting the insufficient font information on the insufficient font data that is not stored in the font data storing section out of the font data used for this image data; a font data retrieving processing for retrieving the insufficient font data in the information processing apparatus connected to the network based on the insufficient font information and acquiring this insufficient font data; and a font data adding processing for controlling to add and store the insufficient font data in the aforementioned font data storing section when this insufficient font data is acquired.

According to the second aspect of the present invention, the font data is previously stored, the data forming the image data is inputted, the insufficient font information on the insufficient font data that is not previously stored in the font data storing section is detected out of the font data used for the image data when this image data is inputted, and the insufficient font data is controlled to be added and stored when this insufficient font data is acquired by retrieving it in the information processing apparatus connected to the aforementioned network based on this insufficient font information. Therefore, even if the font data used for the image data such as inputted document data is insufficient on the side of the input, this insufficient font data can be acquired from an external information processing apparatus through the network, thus making it possible to display the image data.

Also, when the address book serves as the aforementioned image data, the quantity of the image data is small, and the insufficient font data that is not stored in the font data storing section is also small. Therefore, a required storage capacity may be small, and an advantage is that a high speed operation is attained.

Further, by controlling to perform format conversion of the font data as described above in accordance with the display mode and the image forming mode, the font data can be flexibly used depending on various modes, such as displaying a common font data or adding it to the image data.

### BRIEF DESCRIPTION OF THE DRAWING

FIG. 1 is a block diagram showing a first embodiment of an image forming apparatus of the present invention, together with an MFP.

FIG. 2 is a block diagram showing a constitutional example of an image control section according to the first embodiment.

FIG. 3 is a block diagram showing a second embodiment of the image forming apparatus of the present invention, together with the MFP.

FIG. 4 is a block diagram showing the constitutional example of the image control section according to the second embodiment.

FIG. 5 is a block diagram showing an example of a conventional MFP.

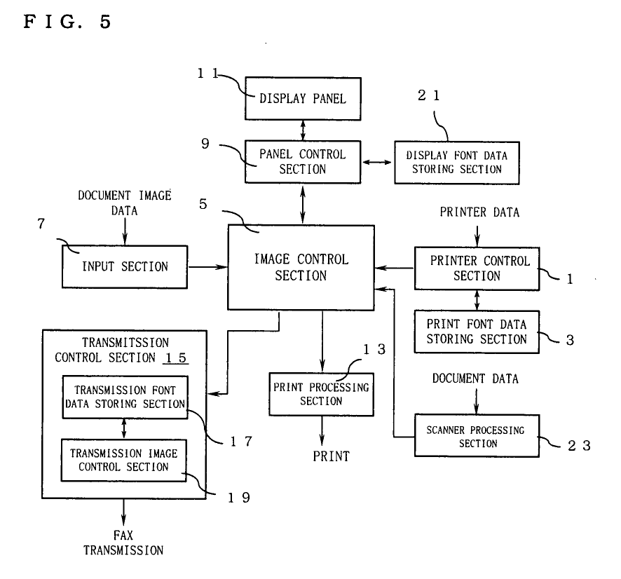

### DETAILED DESCRIPTION OF THE PRESENT INVENTION

Preferred embodiments of the present invention will be explained hereunder, with reference to the drawings.

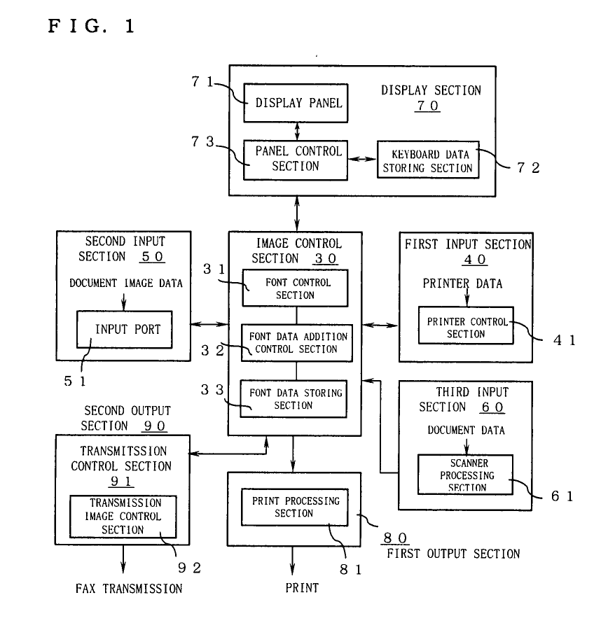

FIG. 1 is a block diagram showing a first embodiment of an image forming apparatus of the present invention, together with an MFP.

In FIG. 1, the MFP on which the image forming apparatus of the present invention is mounted, has a first input section 40, a second input section 50, a third input section 60, a display section 70, a first output section 80, and a second output section 90, with an image control section 30 schematically set as a center.

The image control section 30 has a font control section 31, a font data addition control section 32, and a font data storing section 33. A detailed function will be described later.

The first input section 40 has a printer control section 41, and has a function of inputting printer (image) data from an external computer not shown to the printer control section 41, and in this printer control section 41, preparing print image data from the printer data by using font data as will be described later obtained through the font control section 31, and outputting it to the image control section 30.

The second input section 50 functions as an input port 51 for inputting document image data such as an address book and the font data used for this image data from an external storage medium such as a USB memory not shown and outputting it to the image control section 30, under a control of the image control section 30.

Namely, the USB memory stores the image data and the font data complying with characters, etc, forming this image data.

The third input section 60 has a scanner processing section 61, and has a conventionally known function of optically reading a paper manuscript by this scanner processing section 61 and converting it into electronic image data, and outputting it to the image control section 30.

The display section 70 has a conventionally known display panel 71 having a panel display function and a touch type input function, a keyboard data storing section 72 for storing a plurality of keyboard array data for each language displayed on this display panel 71, and a panel control section 73 for preparing a display keyboard image based on the keyboard array data and displaying it on the display panel 71.

In the keyboard data storing section 72, the keyboard array data of a standard language such as Japanese and key font data used in this key position are previously stored.

The panel control section 73 has a function of outputting instruction information inputted and instructed from the display panel 71 by a touch input of an operator, to the image control section 30.

The first output section 80 is a conventionally known printing engine, etc, for printing the image data on papers, such as the image data from the first to third input sections 40, 50, 60 outputted from the image control section 30.

The second output section 90 is a transmission control section 91 for converting a font-imprinted image data into a prescribed signal for transmission, and faxing it to an external network (not shown), for example, through a prescribed protocol. The second output section 90 has a transmission image control section 92 for adding the font data outputted from the font control section 31 to the header and footer of the transmitted image data, as names and IDs of the transmission source and the transmission destination.

The image control section 30 controls to store language font data so that it can be read and written, in the aforementioned font control section 31, font data addition control section 32, and font data storing section 33. The image control section 30 has a function of recognizing the font data such as characters used in the display of the image data and so forth when this image data is controlled to be inputted from the input port 51, retrieving the insufficient font data in the font data storing section 33, and controlling to add and store this insufficient font data in the font data storing section 33 so that only this insufficient font data is associated with characters, when there is the insufficient font data that is not stored in the font data storing section 33.

The image control section 30 has a function of preparing the display data for displaying an operation state of this apparatus and outputting it to the panel control section 73. Based on an input instruction from the display panel 71, the image control section 30 has a function of outputting the input image data from the scanner processing section 61 or the input port 51 to a print processing section 81 as the print image data or outputting it to the transmission control section 91 as the transmitted image data, and in addition has a function as will be described later.

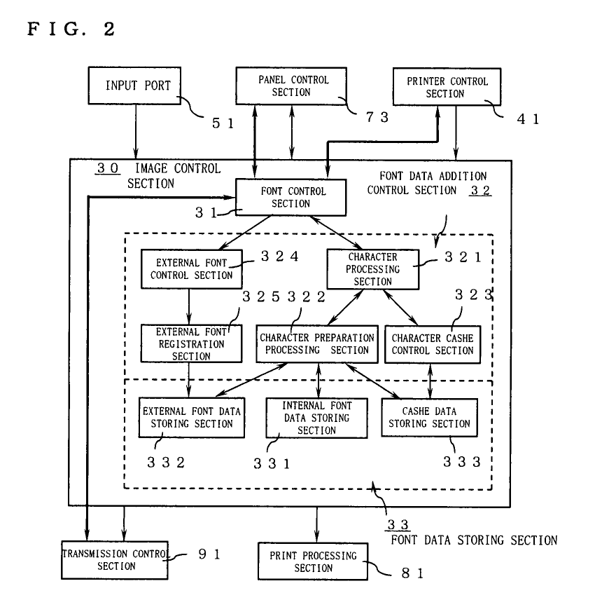

The font data addition control section 32 and the font data storing section 33 of the image control section 30 has a structure as shown in FIG. 2.

The font data addition control section 32 has a character processing section 321 connected to the font control section 31, a character preparation processing section 322 and a character cashe control section 323 connected to this character processing section 321, and also an external font control section 324 connected to the font control section 31, and an external font registration processing section 325 connected to this external font control section 324, and the font data addition control section 32 has a function of controlling reading/writing of the font data to the font data storing section 33.

The font data addition control section 32 has a main function of the aforementioned image control section 30, such as retrieving the insufficient font data used for this image data in the font data storing section, when this image data is inputted from the input port 51 and if there is the insufficient font data, controlling to add and store only this insufficient font data in the font data storing section 33.

The font data storing section 33 has an internal font data storing section 331 connected to the character preparation processing section 322, the external font data storing section 332 and the cashe data storing section 333, and has a function of storing the font data corresponding to a character code and a symbol code so that it can be read and written in association with this character, etc. The external font data storing section 332 is connected to the external font registration processing section 325, and the cashe data storing section 333 is connected to the character CASHE control section 323, respectively.

In the internal font data storing section 331, Japanese, etc, is previously stored as a standard language font data. The font data addition control section 32 stores and manages a plurality of kinds of language font data, for every languages in the external font data storing section 332.

As described above, out of the font data used for displaying, printing, or transmitting the image data, the font control section 31 adds and stores only the insufficient font data in the external font data storing section 332, through the font data addition control section 32, if there is the insufficient font data in the image control section 30 on the side of input, namely, in the internal and external font data storing sections 331 and 332.

Then, based on the instruction from the font control section 31, when the font data corresponding to the character code, etc, is required, the character processing section 321 reads the font data corresponding to the character code from the internal or external font data storing sections 331 and 332 through the character preparation processing section 322, and outputs it to the font control section 31. The character processing section 321 stores the font data thus read once in the CASHE data storing section 333 through the character CASHE control section 323, and based on a re-read instruction from the font control section 31, reads the font data corresponding to the character code through the character cashe control section 323, and outputs it to the font control section 31.

The font control section 31 performs format conversion of the font data thus acquired in accordance with the display mode displayed on the display panel 11, and controls to output it to the panel control section 73. Further, the font control section 31 has a function of performing format conversion of the font data thus acquired in accordance with the image forming mode of the print image data and controlling to output it to the printer control section 41, and also performing format conversion of the font data in accordance with an addition mode to a header and footer in the transmitted image data as the address book and other document data, and controlling to output it to the transmission image control section 91.

Namely, the font control section 31 also has a function of controlling to convert the font data thus acquired, in accordance with the display mode and a mode used in the print image data or the transmitted image data, respectively.

Next, an operation of the aforementioned first aspect will be simply explained.

First, an additional registration operation of language font data will be explained.

For example, when the external storage medium such as a USB memory, wherein the document image data and the language font data used for this image data are stored, is connected to the input port 51 of the second input section 50, the image data and the font data are inputted to the image control section 30, under the control of the image control section 30 based on the instruction from the display panel 71.

In the image control section 30, the font control section 31 recognizes the font data, and retrieves existence/non-existence of the insufficient font data in the internal and external font data storing sections 331 and 332 thorough the character processing section 321 and the character preparation processing section 322. When the insufficient font data exists, the font control section 31 adds and stores only the insufficient font data in the external font data storing section 332, so that it is associated with the character code, through the external font control section 324 and the external font registration processing section 325.

Then, when the inputted image data is displayed on the display panel 71, for example, based on a selection instruction in the display panel 71, the panel control section 73 reads and displays a desired keyboard array data, etc, from the keyboard data storing section 72.

Meanwhile, the font control section 31 acquires the font data corresponding to the character code used for the display of the keyboard array data, from the external font data storing section 332 through the character processing section 321 and the character preparation processing section 322, and from the cashe data storing section 333 through the character cashe control section 323. Then, it performs format conversion of the font data in the display mode of the image data and outputs it to the panel control section 73. The panel control section 9 displays an image on the display panel 11 including added font data.

Incidentally, when the print image data is formed from the printer data by using the font data, based on the instruction from the printer control section 41, the font control section 31 acquires the corresponding font data from the internal and external font data storing sections 331 and 332 through the character processing section 321 and the character preparation processing section 322, and from the cashe data storing section 333 through the character cashe control section 323, and in accordance with a forming mode of the print image data, performs format conversion of the font data and outputs the converted font data to the printer control section 41.

The printer control section 41 forms the print image data by using the converted font data and outputs it to the image control section 30. The same thing can be said for the font data added to the transmitted image data.

The first aspect of the present invention provides the image forming apparatus including the font data storing section 33 wherein the font data is previously stored; the input port (input section) 51 for inputting from outside the image data and the font data used for this image data; and the font data addition control section 32 for recognizing the font data used for this image data when this image data is inputted to this input port (input section) 51 and out of the font data thus recognized, controlling to add and store in the font data storing section only the insufficient font data that is not stored in the font data storing section 33.

Therefore, even if the font data used for the image data such as inputted document data is insufficient on the side of input, no trouble occurs in displaying and printing the inputted image data. In addition, this insufficient font data can be automatically captured together with the image data.

In addition, when the aforementioned image data is the address book, the quantity of the image data is small, and the insufficient font data that is not stored in the font data storing section 33 is extremely small, and duplicate capture of the font data already stored on the side of input is avoided. Therefore, there is an advantage that the storage capacity required for adding the font data may be small, and the operation is prevented from being made slower.

Further, by providing the font control section 31 for controlling to perform format conversion of the font data in accordance with the display mode or the image forming mode, additional change of the font data is easy, and by using character font data thus additionally changed, the display data, the print image data, and the transmitted image data can be easily prepared.

In addition, since the font data addition control section 32 manages and controls to store a plurality of kinds of language font data for every languages, the additional change of a plurality of language font data is easy, and by sharing the language font data thus changed, the print image data and the transmitted image data can be easily prepared. The MFP can be used in a plurality of countries.

According to the image forming control program of the first aspect of the present invention, this program makes the computer for image forming control having the font data addition control section 32 and the font data storing section 33 execute the input processing for inputting from the input section the image data and the font data used for this image data; and the font data addition processing for controlling to add and store in the font data storing section 33 insufficient font data that is not previously stored in the font data storing section 33 out of the font data used for this image data. Whereby the same advantage as that of the image forming apparatus according to the first aspect can be obtained.

Next, an embodiment of the second aspect of the image forming apparatus of the present invention will be explained with reference to the drawings.

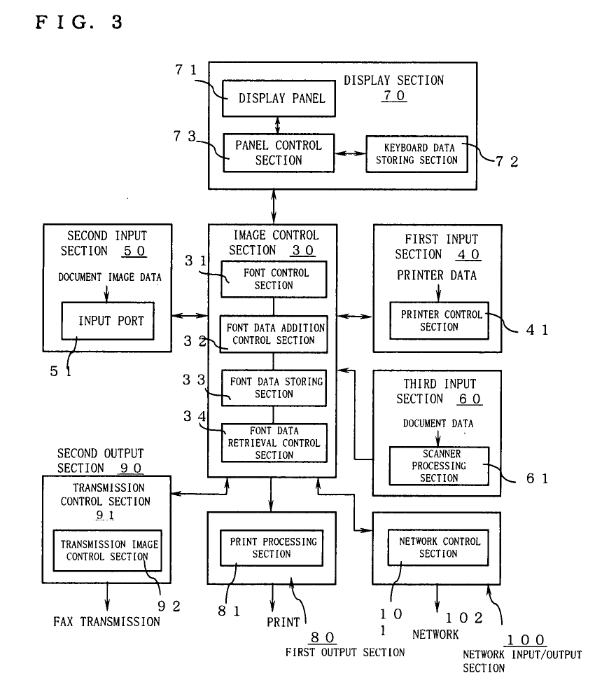

FIG. 3 is a block diagram showing an embodiment of the second aspect of the present invention.

In FIG. 3, the second aspect of the present invention provides the image forming apparatus including the first input section 40, the second input section 50, the third input section 60, the display section 70, the first output section 80, the second output section 90, and a network input/output section 100, with the image control section 30 schematically set as a center, and is different from the first aspect in the point that the network input/output section 100 is provided.

The image control section 30 has the font control section 31, the font data addition control section 32, the font data storing section 33, and a font data retrieval control section 34, and is different from the first aspect in the point that the font data retrieval control section 34 is provided. The detailed function will be described later.

The first input section 40, the second input section 50, the third input section 60, the display section 70, the keyboard data storing section 72, the panel control section 73, the first output section 80 and the second output section 90 have the same structures as those of the first aspect, and the explanation therefore is omitted.

As will be described later, the network input/output section 100 has a network control section 101 for controlling the network 102 to retrieve the insufficient font data, based on the insufficient font information from the font data retrieval control section 34 of the image control section 30.

The image control section 30 controls to store and read the language font data so as to be read and written, in the aforementioned font control section 31, font data addition control section 32, and font data storing section 33.

When the input control of the image data is performed from the first to third input sections 40, 50, and 60, the image control section 30 has a function of recognizing the font data corresponding to the character code, etc, used for displaying and the like of this image data, and retrieving the existence/non-existence of the insufficient font data in the font data storing section 33, and when there is the insufficient font data that is not stored in the font data storing section 33, forming the insufficient font information according to this insufficient font data, and based on this insufficient font information, when the insufficient font data is inputted from outside, controlling to add and store this insufficient font data in the font data storing section 33 so that it is associated with the character, etc.

In the font data retrieval control section 34, the image control section 30 has a function of forming insufficient font acquisition information from the insufficient font information and outputting it to the network control section 101, and controlling to add and store the insufficient font data acquired through the network control section 101, in the font data storing section 33 through the font control section 31. Details are described later.

In the same way as the first aspect, the image control section 30 has a function of preparing the display data for displaying an operation state and outputting it to the panel control section 73, and based on the instruction from the display panel 71, outputting the input image data from the printer control section 41, the scanner processing section 61, or the input port 51, to the print processing section 81 as the print image data, and outputting it to the transmission control section 91 as the transmitted image data, and other functions.

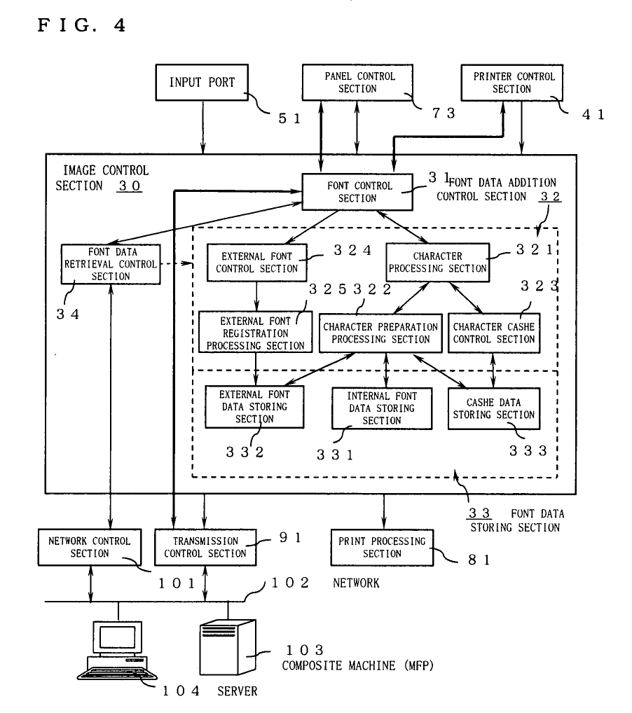

The font data addition control section 32, the font data storing section 33, and the font data retrieval control section 34 of the image control section 30 have the structure as shown in FIG. 4, and have the same structure as the first aspect.

The font data retrieval control section 34 connected to the font control section 31 has a function of preparing the insufficient font acquisition information from the insufficient font information from the font control section 31, and controlling to output it to the network control section 101, and also controlling to output the insufficient font data acquired through the font control section 31 to the font control section 31.

The insufficient font acquisition information includes previously registered IP address of a MFP 103 and a server 104 connected to the network 102, required insufficient font data, and an instruction to retrieve this insufficient font data, whereby the instruction is given to retrieve the insufficient font data by designating the MFP 103 and the server 104 connected to the network 102, and when the insufficient font data exists, it is returned.

The network control section 101 has an interface function of sending insufficient font acquisition information, etc, to a publicly-known network 102, and receiving and decoding the insufficient font data, etc, sent from the MFP 103 and the server 104 as external information apparatus connected to the network 102, for example, and outputting it to the font data retrieval control section 34.

The MFP 103 and the server 104 have a function of receiving the insufficient font acquisition information, etc, and if the corresponding font data exists, returning it to the network control section 101 through the network 102.

When the insufficient font information on the font data used for the image data is obtained, the aforementioned font control section 31 outputs it to the font data retrieval control section 34, and when the insufficient font data is obtained from the font data retrieval control section 34, adds and stores it in the external font data storing section 332 through the font data addition control section 32.

Other function of the font control section 31, namely, the function of respectively controlling to convert the font data acquired in accordance with the display mode and the mode used for the image data such as print image data or transmitted image data, etc, has the same structure as the first aspect.

Next, the aforementioned second aspect is simply explained.

First, additional registration operation of the language font data is explained.

For example, when the external storage medium such as a USB memory storing the document image data, etc, is connected to the input port 51 of the second input section 50, the font data is inputted in the image control section 30 as the image data, under the control of the image control section 30 based on the instruction from the display panel 71.

In the image control section 30, the font data addition control section 32 retrieves the insufficient font data in the internal and external font data storing sections 331 and 332, through the character processing section 321 and the character preparation processing section 322. If the insufficient font data exists, the font control section 31 prepares the insufficient font information and transfers it to the font data retrieval control section 34.

The font data retrieval control section 34, based on the insufficient font acquisition information, forms the insufficient font acquisition information including the IP address for the previously registered MFP 103 and server 104, and retrieves the insufficient font data in the external MFP 103 and server 104 through the network control section 101.

When such an insufficient font data exists in the MFP 103 and the server 104 and is returned, the font data retrieval control section 34 outputs the insufficient font data to the font control section 31, and the font control section 31 adds and stores the insufficient font data in the external font data storing section 332, so that only the insufficient font data is associated with the character code through the external font control section 324 and the external font registration processing section 325.

When the inputted image data is displayed on the display panel 71, for example, when the print image data is formed from the printer data by using the font data, and when the font data is added to the transmitted image data, a format conversion operation of the font control section 31 has the same structure as the first aspect.

As described above, the second aspect of the present invention provides the image forming apparatus, including the font data storing section 33 for storing the font data; the first to third input sections 40, 50, and 60 for inputting data forming the image data; the font data addition control section 32 for detecting the insufficient font information on the insufficient font data that is not stored in the font data storing section out of the font data used for the image data, and controlling to add and store the insufficient font data in the font data storing section 33 when this insufficient font data is inputted; and the font data retrieval control section 34 for controlling to retrieve the insufficient font data in the MFP 103 and the server 104 (information processing apparatus) connected to the network 102 based on the insufficient font information, and when the insufficient font data is acquired, controlling to output it to the font data addition control section 32 through the font control section 31.

Therefore, even if the font data used for the image data such as inputted document data is insufficient on the side of input, trouble does not occur in displaying and printing the input image data. In addition, only the insufficient font data can be automatically captured from the MFP 103 and the server 104 connected to the network 102.

Also, when the aforementioned image data is the address book, the quantity of the image data is small, and the insufficient font data that is not stored in the font data storing section 33 is extremely small, and a duplicate capture of the font data already stored on the side of input is avoided. Therefore, the storage capacity required for adding the font data may be small, and there is an advantage that the operation is prevented from being made slower.

Further, by providing the font control section 31 for controlling to convert the format of the aforementioned font data in accordance with the display mode or the image forming mode, the additional change of the font data is easy, and by using the font data thus additionally changed, the display data, the print image data, and the transmitted image data can be easily prepared.

In addition, the font data addition control section 32 manages and controls to store a plurality of kinds of language font data for every languages. Therefore, the additional change of the plurality of language font data is easy, and by sharing the language font data thus changed, the print image data and the transmitted image data can be easily prepared. The MFP can be used in a plurality of countries.

Note that the second aspect of the present invention is not limited to a structure wherein the insufficient font data is controlled to be outputted to the font data addition control section 32 through the font control section 31, but the insufficient font data can be directly or indirectly controlled to be outputted to the font data addition control section 32 side from the font data retrieval control section 34.

Further, the second output section 90 and the network input/output section 100 as the output section is dividedly shown. However, in an actual product, they have functions as the same structure in many cases.

According to the image forming control program of the second aspect of the present invention, this program makes the computer for image forming control having the font data addition control section 32, the font data storing section 33, and the font data retrieval control section 34, execute the input processing for inputting the data forming the image data, the font detecting processing for detecting the insufficient font information on the insufficient font data that is not stored in the font data storing section 33 out of the font data used for this image data, the font data retrieval processing for retrieving the insufficient font data in the information processing apparatus connected to the network 102 based on the insufficient font information, and the font data addition processing for controlling to add and store the insufficient font data in the aforementioned font data storing section 33 when this insufficient font data is acquired. The same advantage as that of the image forming apparatus of the second aspect can be obtained.

In addition, although the input port 51 of the second input section 50 is used as the input section of the data forming the image data in the aforementioned first and second aspects of the present invention, the first and third input sections 40 and 60, and the network input/output section 100 may also be the input section of the data forming the image data.

Note that the image forming apparatus according to the present invention can be executed not only in the character data, but also in the font data on characters, codes, and other symbols.

1. An image forming apparatus, comprising:
a font data storing section for storing font data;
an input section for inputting from outside image data and font data used for this image data; and
a font data addition control section for recognizing said font data used for this image data when this image data is inputted to the input section and out of the font data thus recognized, controlling to add and store in said font data storing section insufficient font data that is not stored in the font data storing section.

2. The image forming apparatus according to claim 1, wherein said image data is an address book.

3. The image forming apparatus according to claim 1, having a font control section for performing format conversion of said font data in accordance with a display mode or an image forming mode.

4. An image forming control program, which makes a computer for image forming control that controls to add insufficient font data that is not stored in a font data storing section where font data is previously stored, execute
an input processing for inputting from an input section image data and the font data used for this image data; and
a font data addition processing for controlling to add and store in said font data storing section said insufficient font data that is not stored in said font data storing section out of said font data used for the image data, when said image data is inputted.

5. The image forming control program according to claim 4, wherein said image data is an address book.

6. The image forming control program according to claim 4, which executes a font control processing of controlling to perform format conversion of said font data in accordance with a display mode or an image forming mode.

7. An image forming apparatus, which is connected to a network, comprising:
a font data storing section for storing font data;
an input section for inputting data forming image data;
a font data addition control section for detecting insufficient font information on insufficient font data that is not stored in said font data storing section out of the font data used for said image data, and controlling to add and store said insufficient font data in said font data storing section when this insufficient font data is inputted; and
a font data retrieval control section for controlling to retrieve said insufficient font data in an information processing apparatus connected to said network based on said insufficient font information, and controlling to output it to said font data addition control section side when said insufficient font data is acquired.

8. The image forming apparatus according to claim 7, wherein said image data is an address book.

9. The image forming apparatus according to claim 7, having a font control section for controlling to convert a format of said font data in accordance with a display mode or an image forming mode.

10. An image forming control program, which makes a computer for image forming control connected to a network, so that font data can be added to a font data storing section in which the font data is stored, execute
an input processing for inputting data forming image data;
an insufficient font detection processing for detecting insufficient font information on insufficient font data that is not stored in said font data storing section out of the font data used for said image data;
a font data retrieval processing for retrieving said insufficient font data in the information processing apparatus connected to said network based on this insufficient font information and acquiring said insufficient font data; and
a font data addition processing for controlling to add and store said insufficient font data in said font data storing section when said insufficient font data is acquired.

11. The image forming control program according to claim 10, wherein said image data is an address book.

12. The image forming control program according to claim 10, which executes a font control processing of controlling to perform format conversion of said font data in accordance with a display mode or an image forming mode.

13. The image forming apparatus according to claim 2, having a font control section for performing format conversion of said font data in accordance with a display mode or an image forming mode.

14. The image forming control program according to claim 5, which executes a font control processing of controlling to perform format conversion of said font data in accordance with a display mode or an image forming mode.

15. The image forming apparatus according to claim 8, having a font control section for controlling to convert a format of said font data in accordance with a display mode or an image forming mode.

16. The image forming control program according to claim 11, which executes a font control processing of controlling to perform format conversion of said font data in accordance with a display mode or an image forming mode.
